(19) United States
(12) Patent Application Publication
(10) Pub. No.: US 2013/0266220 A1
(43) Pub. Date: Oct. 10, 2013

(54) COLOR SIGNAL PROCESSING CIRCUIT, COLOR SIGNAL PROCESSING METHOD, COLOR REPRODUCTION EVALUATING METHOD, IMAGING APPARATUS, ELECTRONIC APPARATUS AND TESTING DEVICE

(71) Applicant: SONY CORPORATION, Tokyo (JP)

(72) Inventor: Kazuyuki Matsushima, Kanagawa (JP)

(73) Assignee: SONY CORPORATION, Tokyo (JP)

(21) Appl. No.: 13/790,394

(22) Filed: Mar. 8, 2013

(30) Foreign Application Priority Data
Apr. 5, 2012 (JP) 2012-086263

(51) Int. Cl. G06K 9/46

(52) U.S. Cl. CPC G06K 9/4652
USPC 382/167

(57) ABSTRACT

A color signal processing circuit performs a correction process on an input color signal so as to cause a color component to belong to a color reproduction determination range, which is set in a chromaticity diagram to define an allowable range of color discrepancy, using the color reproduction determination range.

### FIELD

The present disclosure relates to a color signal processing circuit, a color signal processing method, a color reproduction evaluating method, an imaging apparatus, an electronic apparatus, and a testing device.

### BACKGROUND

A MacAdam ellipse is known as an evaluation criterion of color discrepancy (color difference). However, this ellipse expresses only a detection limit range of color discrepancy. This ellipse is based on an xy brightness diagram and is plotted in an L*a*b* color space with ten times measured values. In any range, L*=50 is fixed, and thus it is an evaluation criterion which is difficult to use in practice.

On the other hand, a technique of comparing an image signal with a determination value and inputting a matrix coefficient corresponding to the comparison result has been proposed as a technique of correcting color reproduction of an image signal (for example, see JP-A-2005-159879).

### SUMMARY

However, in the technique described in JP-A-2005-159879, excessive correction is performed to perform a correction process of accurately matching the detection value. Noise increases due to the excessive correction and thus S/N degradation is caused. The accuracy of color reproduction is not good.

Therefore, it is desirable to provide a color signal processing circuit and a color signal processing method which can realize an optimal correction of color reproduction corresponding to various imaging conditions without performing excessive correction and a color reproduction evaluating method, an imaging apparatus, an electronic apparatus, and a testing device to which the technique of the circuit or method is applied.

An embodiment of the present disclosure is directed to a color signal processing circuit that performs a correction process on an input color signal so as to cause a color component to belong to a color reproduction determination range, which is set in a chromaticity diagram to define an allowable range of color discrepancy, using the color reproduction determination range.

Another embodiment of the present disclosure is directed to a color signal processing method including: setting a color reproduction determination range, which defines an allowable range of color discrepancy, in a chromaticity diagram; and performing a correction process on an input color signal so as to cause a color component to belong to the color reproduction determination range.

A color reproduction determination range which does not defines a detection limit range of color discrepancy (color difference) but defines an allowable range of color discrepancy is set in a chromaticity diagram, and a correction process is performed so as to cause a color component to belong to the color reproduction determination range, for example, to return a color component outside the range to the range. Accordingly, excessive color correction which is not able to be detected (perceived) by a human being may not be performed.

According to the embodiments of the present disclosure, since excessive color correction which is not visible may not be performed, it is possible to realize the optimal correction of color reproduction corresponding to various imaging conditions.

### BRIEF DESCRIPTION OF THE DRAWINGS

FIG. 1 is a system configuration diagram schematically illustrating the configuration of an imaging apparatus according to a first embodiment of the present disclosure;

FIG. 2 is a diagram illustrating a color reproduction determination range in an L*a*b* chromaticity diagram space;

FIG. 3 is a diagram illustrating an allowable limit range and a detection limit range of red and numerical examples of a detection limit and an allowable limit therein;

FIG. 4 is a diagram illustrating an allowable limit range and a detection limit range of green and numerical examples of a detection limit and an allowable limit therein;

FIG. 5 is a diagram illustrating an allowable limit range and a detection limit range of blue and numerical examples of a detection limit and an allowable limit therein;

FIG. 6 is a diagram illustrating an allowable limit range and a detection limit range of yellow and numerical examples of a detection limit and an allowable limit therein;

FIG. 7 is a diagram illustrating an allowable limit range and a detection limit range of magenta and numerical examples of a detection limit and an allowable limit therein;

FIG. 8 is a diagram illustrating an allowable limit range and a detection limit range of cyan and numerical examples of a detection limit and an allowable limit therein;

FIG. 9 is a diagram illustrating allowable limit ranges and detection limit ranges of six basic colors (R, G, B, Ye, Mg, and Cy) and achromatic colors (22% gray) and numerical examples of a detection limit and an allowable limit therein;

FIG. 10 is a diagram illustrating an example (L*a*b* chromaticity diagram space) of a chromaticity diagram space;

FIG. 11 is a diagram illustrating an example, where the color reproduction determination range of a color other than the basic colors is generated through the use of linear interpolation on the basis of the color reproduction determination ranges of the basic colors;

FIG. 12 is a diagram illustrating an example where a color reproduction reference value and a range size (level) are set by applications of a color reproduction determination range;

FIG. 13 is a diagram illustrating an example of color reproduction reference values set by categories;

FIG. 14 is a diagram illustrating an example of color reproduction determination range set by imaging scenes;

FIG. 15 is a diagram illustrating an example of color reproduction determination ranges set by categories;

FIG. 16 is a flowchart illustrating an example of a process flow of a color signal processing method according to the present disclosure;

FIG. 17 is a diagram illustrating an example of operations and advantages of the present disclosure;

FIG. 18A is a diagram illustrating an example where an image having a sense of discomfort in which red-based noise is conspicuous is corrected with a red-based gain;

FIG. 18B is a-diagram illustrating an example where an image having a sense of discomfort in which red-based noise is conspicuous is corrected with a blue-based gain;

FIG. 19 is a system configuration diagram schematically illustrating the configuration of an imaging apparatus according to a second embodiment of the present disclosure; and

FIG. 20 is a flowchart illustrating an example of a process flow of a specific color reproduction evaluating method according to the present disclosure.

### DETAILED DESCRIPTION

Hereinafter, forms (hereinafter, referred to as “embodiments”) for embodying the technique according to the present disclosure will be described in detail with reference to the accompanying drawings. The present disclosure is not limited to the embodiments, and various numerical values in the embodiments or the like are only examples. In the following description, the same constituents or constituents having the same functions will be referenced by the same reference numerals and description thereof will not be repeated. The description will be made in the following order.

1. General Description of Color Signal Processing Circuit, Color Signal Processing Method, Color Reproduction Evaluating Method, Imaging Apparatus, Electronic Apparatus, and Testing Device

2. Imaging Apparatus according to First Embodiment (Example where Imaging Unit and Signal Processing Unit Are Separated)
2-1. System Configuration
2-2. Color Reproduction Determination Range
2-3. Color Signal Processing Unit
2-4. Color Signal Processing Method

3. Imaging Apparatus according to Second Embodiment (Example where Pixel Unit and Signal Processing Unit Are Unified)
4. Application Example
5. Configuration of Present Disclosure

### 1. General Description of Color Signal Processing Circuit, Color Signal Processing Method, Color Reproduction Evaluating Method, Imaging Apparatus, Electronic Apparatus, And Testing Device

A color signal processing circuit or a color signal processing method according to one embodiment of the present disclosure is a processing circuit or a processing method used to correct color discrepancy (color difference) of a color signal including color components of three primary colors or complementary colors thereof.

The color signal processing circuit or the color signal processing method according to the embodiment of the present disclosure can be used as a circuit that performs a color signal process on a captured image signal from an imaging unit (imaging device) in an imaging apparatus such as a digital still camera, a video camera, and a camera mounted on a portable information terminal having an imaging function like a mobile phone. The color signal processing circuit or the color signal processing method according to the embodiment of the present disclosure is not limited to the imaging apparatus, but may be applied to all electronic apparatuses, which treat a color signal, such as a copier, a facsimile, and a color printer.

The technique of the color signal processing circuit or the color signal processing method according to the embodiment of the present disclosure can be applied to a color reproduction evaluation technique. The color reproduction evaluation technique can be used for a testing device (so-called tester) that evaluates device characteristics such as oblique incidence characteristics of an imaging device. Here, the “oblique incidence characteristics” mean characteristics to light obliquely incident on sensor portions (pixels) of an imaging device.

In the color signal processing circuit or the color signal processing method according to the embodiment of the present disclosure, a correction process is performed on an input color signal so as to cause a color component to belong to a color reproduction determination range, which is set in a chromaticity diagram to define an allowable range of color discrepancy, using the color reproduction determination range. Specifically, a correction process is performed, for example, on a color component departing from the color reproduction determination range so as to return the color component to the color reproduction determination range.

By performing this color correction process, excessive color correction which is not able to be detected (perceived) by a human being does not have to be performed and it is thus possible to realize the optimal correction of color reproduction corresponding to various imaging conditions.

In the color signal processing circuit and the color signal processing method according to the embodiment of the present disclosure including the above-mentioned preferred configuration, the color reproduction determination range can be configured to quantitatively represent an allowable range of color discrepancy in consideration of human visibility characteristics. At this time, the color reproduction determination range may have a configuration including at least an allowable limit range that defines the allowable limit of color discrepancy. It is preferable that the color reproduction determination range includes a detection limit range that defines a limit in which color discrepancy can be detected by a human eye.

In the color signal processing circuit and the color signal processing method according to the embodiment of the present disclosure including the above-mentioned preferred configuration, the color reproduction determination range can be applied to all colors which can be expressed at least in color spaces of an L*a*b* chromaticity diagram space and an L*u*v* chromaticity diagram space.

Here, since the L*a*b* chromaticity diagram space and the L*u*v* chromaticity diagram space are chromaticity diagram spaces in consideration of human visibility characteristics, they are chromaticity diagram spaces desirable for setting the color reproduction determination range.

Here, the chromaticity diagram in which the color reproduction determination range is set is not limited to the chromaticity diagram in consideration of human visibility characteristics, but the color reproduction determination range can be set, for example, in the XYZ chromaticity diagram.

In the color signal processing circuit and the color signal processing method according to the embodiment of the present disclosure including the above-mentioned preferred configuration, the color reproduction determination range can be set for each basic color, where the basic colors include three primary colors such as R (red), G (green), and B (blue) and complementary colors thereof such as yellow (Ye), magenta (Mg), and cyan (Cy).

The color reproduction determination ranges may include color reproduction determination ranges of colors other than the basic colors in addition to the color reproduction determination ranges of the basic colors. At this time, the color reproduction determination ranges of colors other than the basic colors can be set through the use of an interpolation process such as linear interpolation on the basis of the color reproduction determination ranges of the basic colors.

In the color signal processing circuit and the color signal processing method according to the embodiment of the present disclosure including the above-mentioned preferred configuration, the range size (level) and the color reproduction reference value of a color reproduction determination range can be set by applications of the color reproduction determination range.

Here, the term “applications” includes an application having priority in color reproduction and an application having priority in noise characteristics. For example, the range size can be set by applications with conditions that the detection limit range in which color discrepancy is not able to be detected (perceived) by a human eye is applied as the strictest determination range and the allowable limit range in which color discrepancy can be detected but is a difference in allowable level is applied as the second strictest determination range.

Alternatively, in the color signal processing circuit and the color signal processing method according to the embodiment of the present disclosure including the above-mentioned preferred configuration, the range size of a color reproduction determination range can be dynamically set depending on a color reproduction reference value (target color reproduction) in a color space.

A color reproduction evaluating method according to one embodiment of the present disclosure employs the technique of the color signal processing circuit or the color signal processing method according to the embodiment of the present disclosure. That is, in the color reproduction evaluating method according to the embodiment of the present disclosure, a color reproduction determination range that defines an allowable range of color discrepancy is set in a chromaticity diagram and it is evaluated whether a color signal input from a device belongs to the color reproduction determination range.

For example, an imaging device can be used as a target device of the color reproduction evaluating method according to the embodiment of the present disclosure. Imaging devices such as a CCD (Charge Coupled Device) image sensor or a CMOS (Complementary Metal Oxide Semiconductor) image sensor have inferior characteristics (oblique incidence characteristics) to light obliquely incident on sensor portions (pixels).

Specifically, when obliquely-incident light is not concentrated well on the sensor portions in an imaging device, that is, is not efficiently concentrated on the sensor portions, brightness is lowered and thus color reproducibility is lowered. It was difficult to quantitatively evaluate the oblique incidence characteristics of an imaging device in the related art, but it is possible to quantitatively evaluate the oblique incidence characteristics of the imaging device by using the color reproduction evaluating method according to the embodiment of the present disclosure.

An imaging apparatus including an imaging unit that captures a subject image and a signal processing unit that performs a signal process on a captured image signal output from the imaging unit can employ the color signal processing circuit according to the embodiment of the present disclosure including the above-mentioned desirable configuration as the signal processing unit. That is, the imaging apparatus according to the embodiment of the present disclosure includes an imaging unit that captures a subject image and a color signal processing circuit that performs a correction process on a captured image signal input from the imaging unit so as to cause a color component to belong to a color reproduction determination range, which is set in a chromaticity diagram to define an allowable range of color discrepancy, by the use of the color reproduction determination range.

The signal processing unit (color signal processing circuit) of the imaging apparatus may have a configuration in which the signal processing unit is integrally mounted on a board in which sensor portions (pixels) are arranged or may have a configuration in which the signal processing unit is disposed outside the board. In the former, the pixel section (imaging unit) and the signal processing unit are unified to form an imaging device. In the latter, the imaging unit serves as an imaging device and a captured image signal output from the imaging device is processed by the signal processing unit.

In the imaging apparatus according to the embodiment of the present disclosure including the above-mentioned preferred configuration, the range size (level) and the color reproduction reference value of a color reproduction determination range can be set by imaging scenes. Here, the term “imaging scenes” includes an imaging scene in the fine weather, an imaging scene in the cloudy weather, an imaging scene in the sunset, an imaging scene in the night, and the like. The range size can be set by the imaging scenes, for example, in the night, since it is difficult to perceive a variation in color, the color reproduction determination range is reduced.

Alternatively, in the imaging apparatus according to the embodiment of the present disclosure including the above-mentioned preferred to configuration, the range size (level) and the color reproduction reference value of a color reproduction determination range can be set by categories. Here, the term “categories” includes a digital still camera (DSC), a mobile phone camera, and a monitoring camera.

In a digital still camera (DSC), a camcorder, or the like, since color reproduction of a skin color of a person or the like has priority, the strictest (the smallest-size) determination range is set with a focus on the color reproduction to perform color correction. On the other hand, in a monitoring camera such as a security camera, since the feeling of noise has priority rather than the color reproduction, the color correction is performed with a focus on the feeling of noise by sacrificing color reproducibility to lower the determination level (to broaden the range). The color reproducibility and the feeling of noise have a tradeoff relation.

Alternatively, in the imaging apparatus according to the embodiment of the present disclosure including the above-mentioned preferred configuration, the range size and the color reproduction reference value of a color reproduction determination range may be dynamically set at a rate not giving a visual sense of discomfort on the basis of a variation in ambient, brightness or a variation in color ratio. Here, the “rate not giving a visual sense of discomfort” means a rate corresponding to a period of 0 to plural display frames.

Alternatively, when a color reproduction determination range is set for each basic color of three primary colors and complementary colors thereof, the color signal processing circuit may be configured to reduce a red-based color correction value to a level at which color reproducibility is not able to be perceived in the color reproduction determination range of red when capturing an image under a dark environment having illuminance lower than predetermined illuminance. By employing this configuration, it is possible to perform color correction to obtain the optimal feeling of noise depending on the level of color noise of an image.

For example, red-based noise (σa*) is more conspicuous for a human eye rather than blue-based noise (σb*). When capturing an image under a dark environment with low illuminance or the like, it is assumed that there is an image with a sense of discomfort in which red-based noise is conspicuous. In this case, it is possible to obtain an image without a sense of discomfort by reducing a red-based color correction value to a level at which color reproducibility is not able to be perceived by a human eye in the color reproduction determination range of red. On the contrary, it is possible to obtain an image without a sense of discomfort by increasing a blue-based color correction value to a level at which color reproducibility is not able to be perceived by a human eye in the color reproduction determination range of blue.

### 2. Imaging Apparatus According To First Embodiment

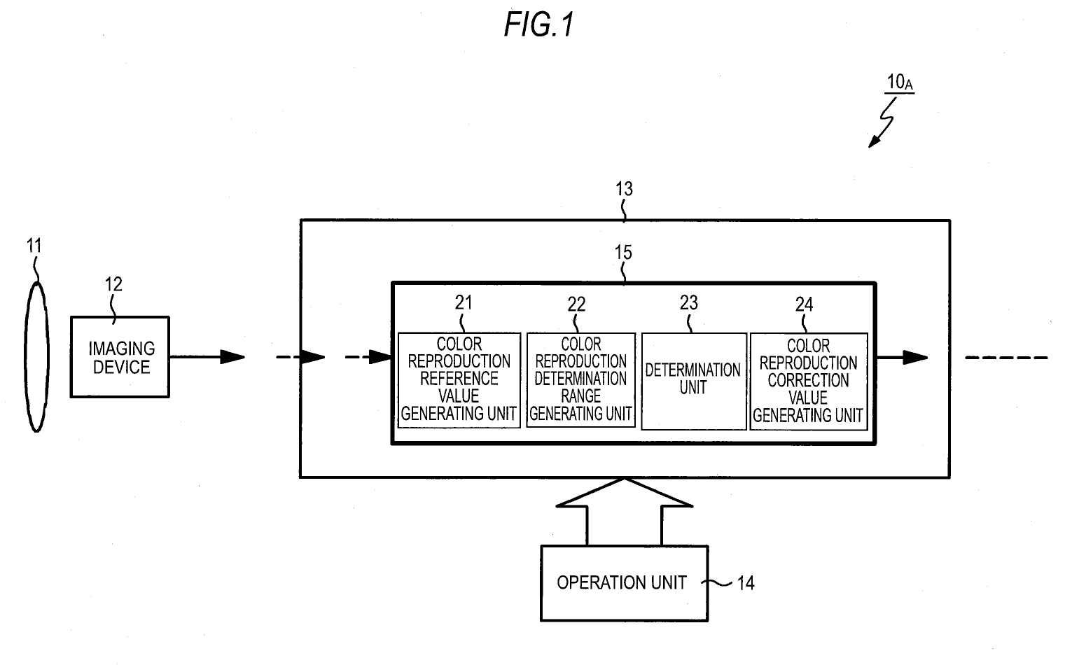

FIG. 1 is a system configuration diagram schematically illustrating the configuration of an imaging apparatus according to a first embodiment of the present disclosure. Examples of the imaging apparatus include a digital still camera, a video camera, a mobile phone camera, and a monitoring camera.

### 2-1. System Configuration

As shown in FIG. 1, an imaging apparatus 10_{A} according to the first embodiment includes an optical system including a lens 11 and an iris diaphragm (not shown), an imaging device 12, a DSP (Digital Signal Processor) unit 13 which is a signal processing unit, and an operation unit 14 on which various operations are performed by a user. The imaging apparatus 10_{A} according to the first embodiment employs a configuration in which the DSP unit 13 is disposed outside the chip of the imaging device 12. The imaging device 12 may be a charge transfer solid-state imaging device such as a CCD image sensor or an enhancement type solid-state imaging device such as a COMS image sensor.

The DSP unit 13 includes a color matrix unit 15. The color matrix unit 15 is a color signal processing unit that performs a process of generating an optimal color in human visibility characteristics on a captured image signal output from the imaging device 12. The technique of the color signal processing circuit or the signal processing method according to the embodiment of the present disclosure is applied to the color signal processing unit, that is, the color matrix unit 15.

The DSP unit 13 includes various circuit units in the front and back of the color matrix unit 14 in addition to the color matrix unit 15. Examples of various circuit units include an A/D converter, a clamping unit, a gamma correction unit, and a brightness/chroma signal generating unit. Since such circuit units are not directly associated with the technique according to the embodiment of the present disclosure, such circuit units are not shown for the purpose of simplification of the drawings.

### 2-2. Color Reproduction Determination Range

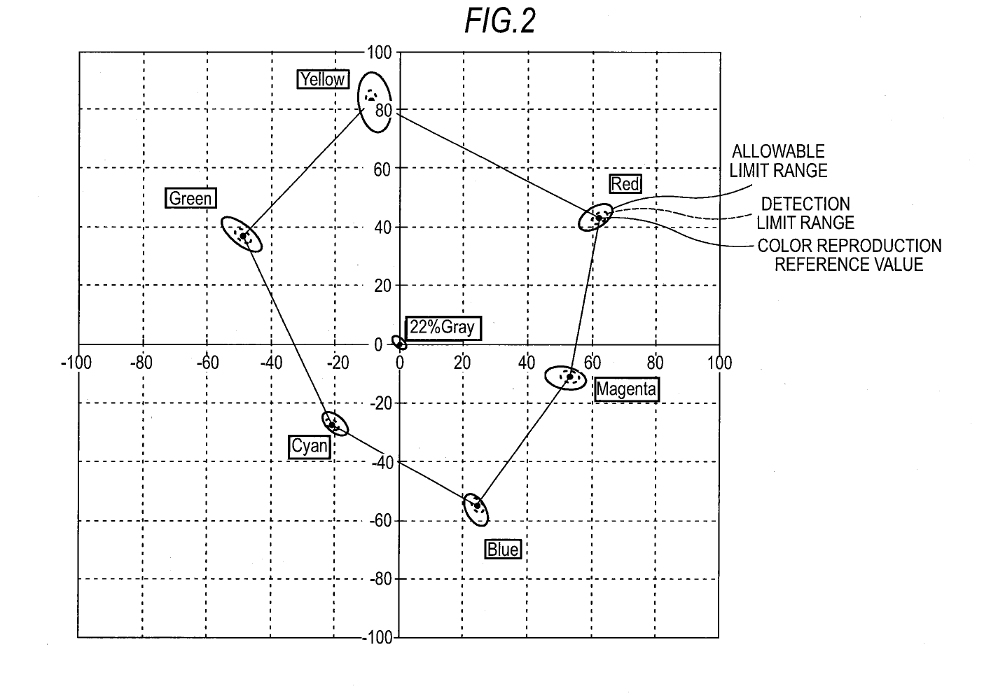

The color matrix unit 15 to which the technique according to the embodiment of the present disclosure is applied, for example, as shown in FIG. 2, sets a color reproduction determination range in an L*a*b* chromaticity diagram space and performs a correction process on an input color signal (captured image signal) to cause the color component thereof to belong to the color reproduction determination range. Here, the L*a*b* chromaticity diagram space is used as an example of the chromaticity diagram space, but the chromaticity diagram space is not limited thereto and, for example, an L*u*v* chromaticity diagram space may be used.

Here, the L*a*b* chromaticity diagram space or the L*u*v* chromaticity diagram space is a color space in consideration of human visibility characteristics and is a desirable chromaticity diagram space for setting a color reproduction determination range. The technique of the embodiment of the present disclosure is not limited to application to a color space in consideration of human visibility characteristics, that is, the L*a*b* chromaticity diagram space or the L*u*v* chromaticity diagram space, but a color reproduction determination range may be set, for example, in an XYZ chromaticity diagram.

A color reproduction determination range is a determination range for defining an allowable range of color discrepancy (color difference) and quantitatively expresses the allowable range of color discrepancy in consideration of human visibility characteristics. As shown in FIG. 2, the color reproduction reference value and the range size of a color reproduction determination range is set for each basic color, where the basic colors include three primary colors, that is, red (R), green (G), and blue (B) and complementary colors thereof, that is, yellow (Ye), magenta (Mg), and cyan (Cy).

A color reproduction determination range may be said to be an allowable limit range that defines an allowable limit of color discrepancy. As shown in FIG. 2, a color reproduction determination range includes a detection limit range that defines a limit at which color discrepancy can be perceived by a human eye, in addition to the allowable limit range. In FIG. 2, a solid line represents the allowable limit range and is an area (range) in which color discrepancy (color difference) within this range can be perceived by a human eye but can be allowed. In FIG. 2, a dotted line represents the detection limit range and is an area in which color discrepancy within this range is not able to be perceived by a human eye.

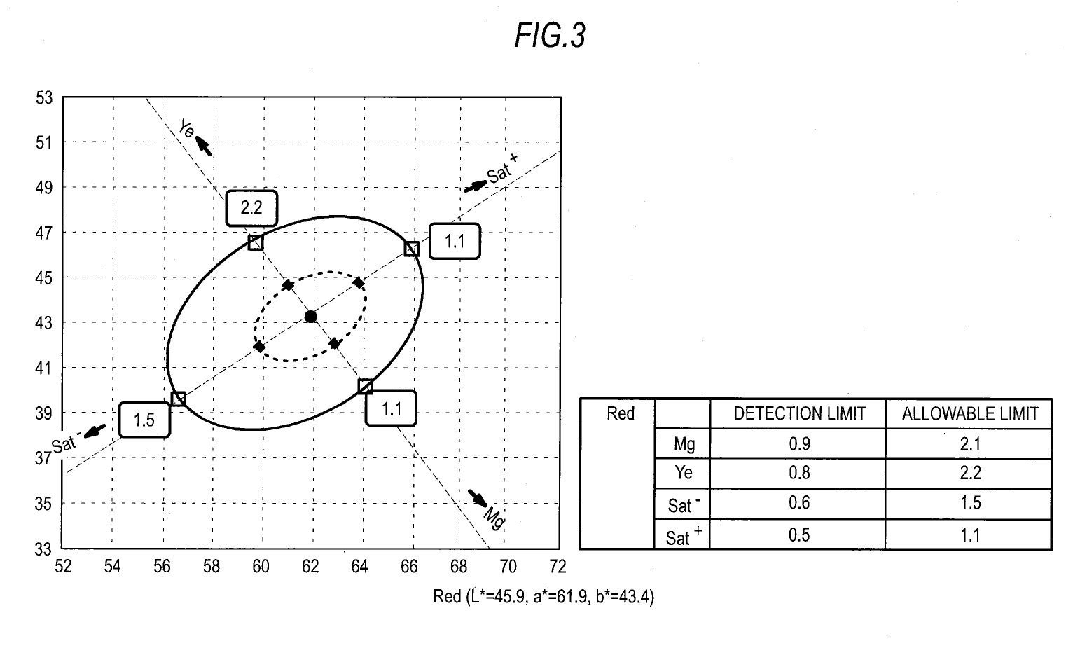

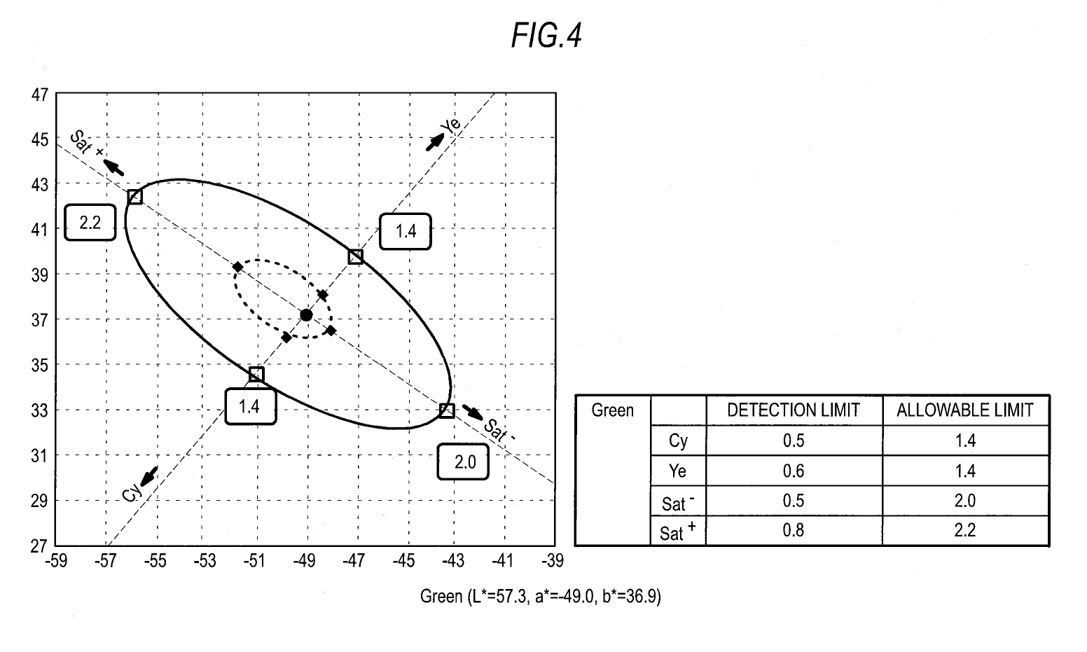

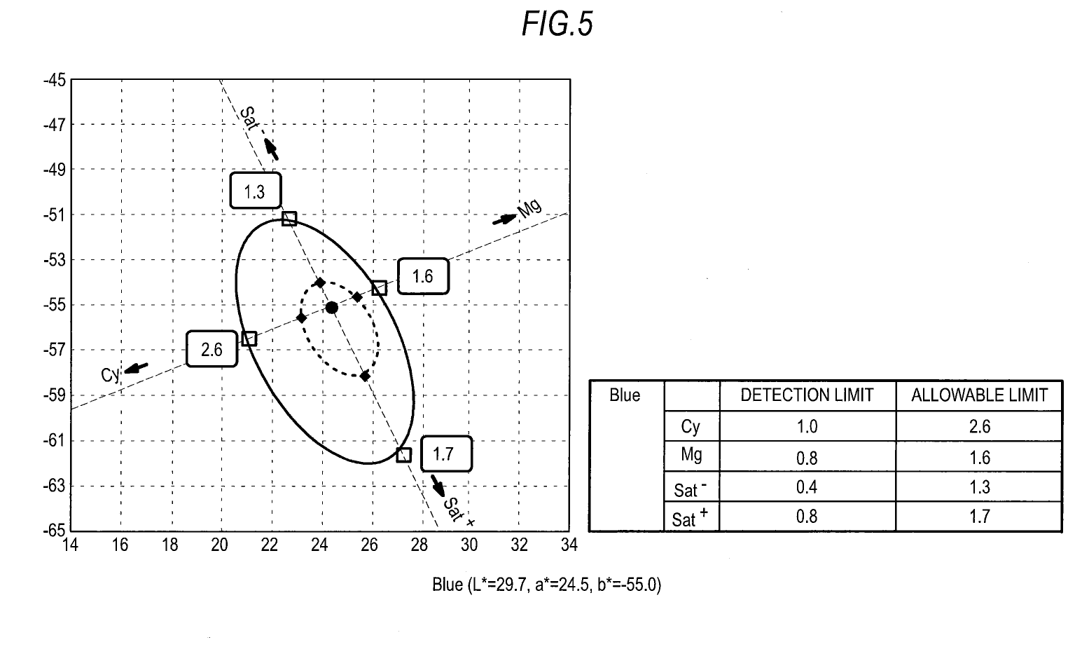

FIGS. 3 to 8 illustrate an allowable limit range (solid line) and a detection limit range (dotted line) for each basic color and numerical examples of a detection limit and an allowable limit therein. All the numerical values are expressed in CIE 2000. FIG. 3 is a diagram illustrating an allowable limit range and a detection limit range of red and numerical examples of a detection limit and an allowable limit therein. FIG. 4 is a diagram illustrating an allowable limit range and a detection limit range of green and numerical examples of a detection limit and an allowable limit therein. FIG. 5 is a diagram illustrating an allowable limit range and a detection limit range of blue and numerical examples of a detection limit and an allowable limit therein.

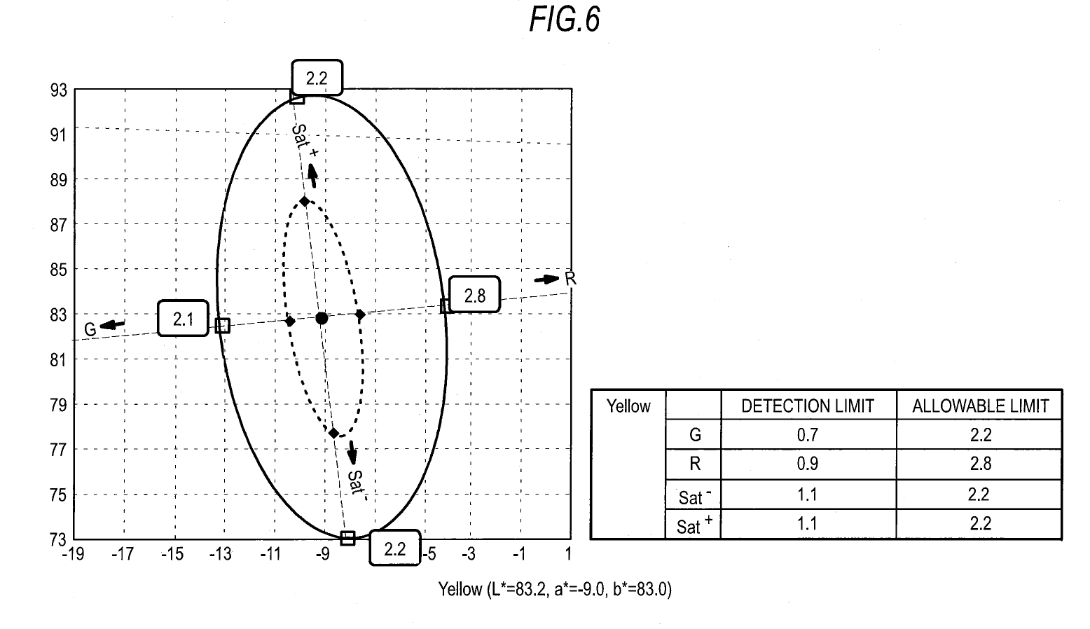

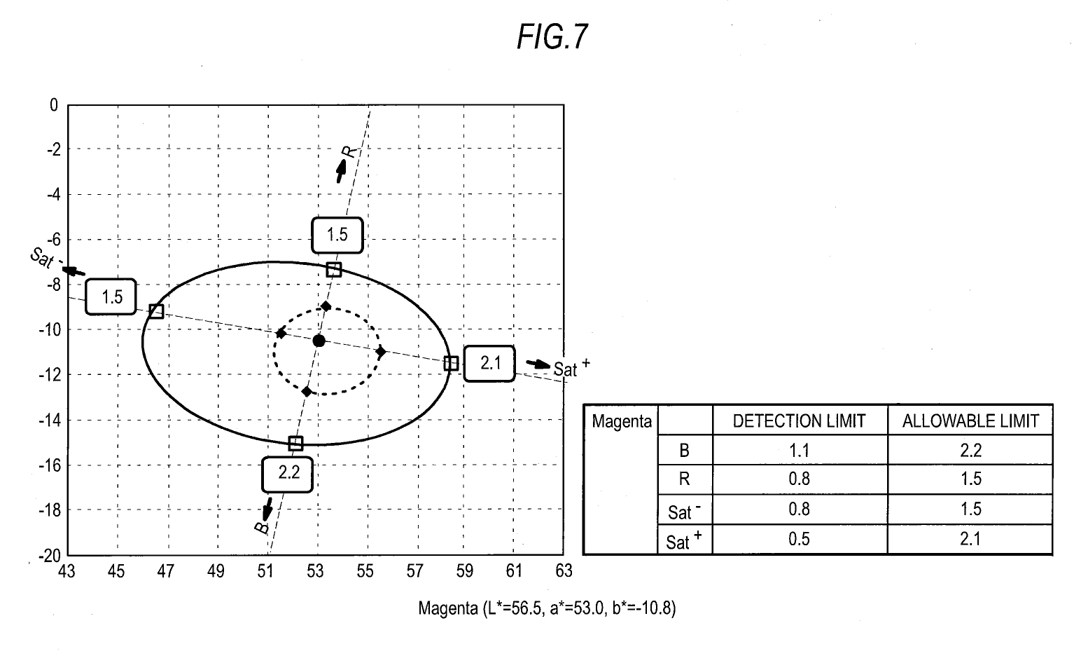

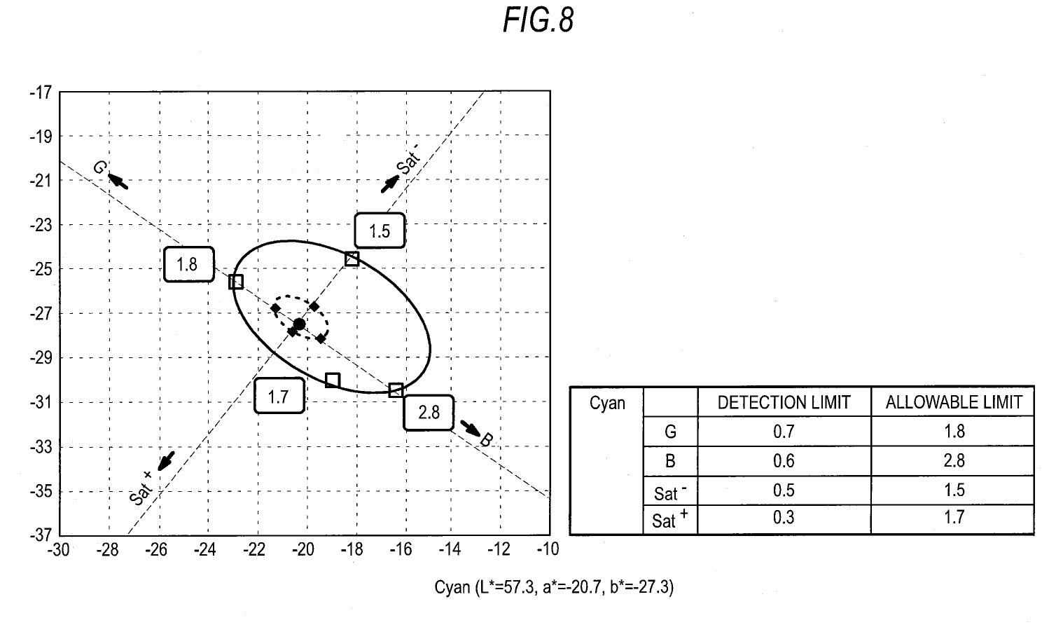

FIG. 6 is a diagram illustrating an allowable limit range and a detection limit range of yellow and numerical examples of a detection limit and an allowable limit therein. FIG. 7 is a diagram illustrating an allowable limit range and a detection limit range of magenta and numerical examples of a detection limit and an allowable limit therein. FIG. 8 is a diagram illustrating an allowable limit range and a detection limit range of cyan and numerical examples of a detection limit and an allowable limit therein.

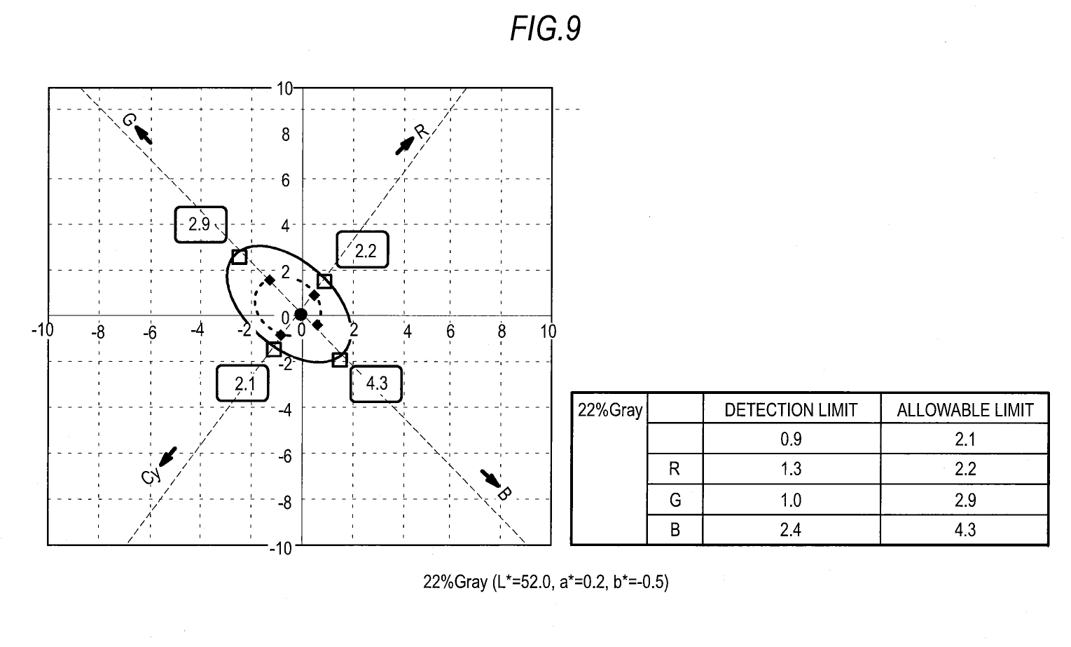

FIG. 9 shows allowable limit ranges and detection limit ranges of six basic colors (R, G, B, Ye, Mg, and Cy) and achromatic colors (22% gray) and numerical examples of the detection limit and the allowable limit therein. As shown in FIG. 9, the allowable limit range and the detection limit range can be applied to all colors which can be expressed in the color space of an L*a*b* chromaticity diagram space.

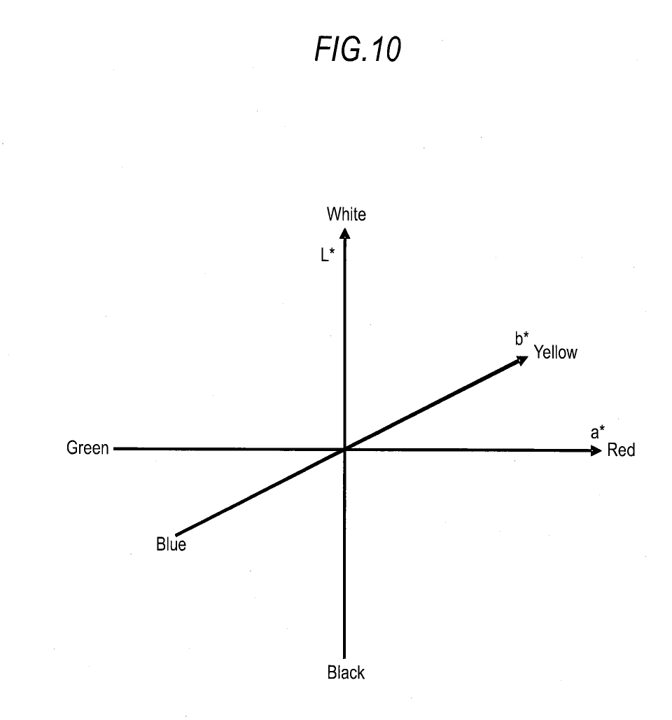

FIG. 10 shows an example (L*a*b* chromaticity diagram space) of the chromaticity diagram space. As shown in the drawing, the color reproduction determination range such as the allowable limit range and the detection limit range can be applied to all colors which can be expressed in the color space of an L*a*b* chromaticity diagram space.

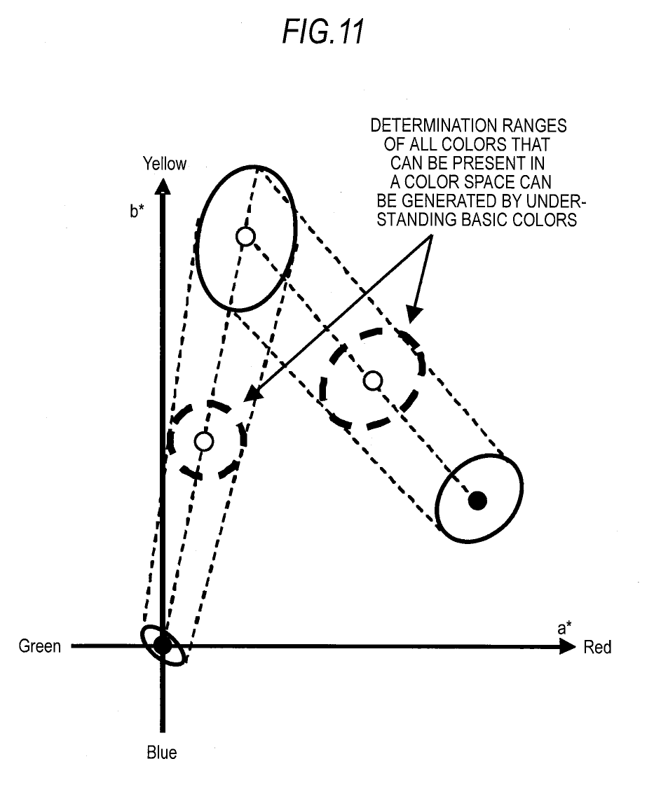

It has been hitherto stated that the color reproduction determination ranges such as the allowable limit ranges and the detection limit ranges of six basic colors are set, but a color reproduction determination range of any color other than the six basic colors can be set as long as it can be calculated in the chromaticity diagram shown in FIG. 10 or the like. Specifically, as shown in FIG. 11, the color reproduction determination range of a color other than the basic colors can be easily set through the use of an interpolation process such as linear interpolation based on the color reproduction determination ranges of the basic colors. FIG. 11 shows an example where the color reproduction determination range of a color other than the basic colors is generated from the color reproduction determination ranges of yellow and red and the color reproduction determination ranges of yellow and an achromatic color.

Plural range sizes (levels) may be provided to the color reproduction determination range of each color and the range size and the color reproduction reference value may be changed depending on applications of the color reproduction determination range, that is, picture-making ideas. Here, the term “applications” means an application having priority in color reproduction, an application having priority in noise characteristics, and the like.

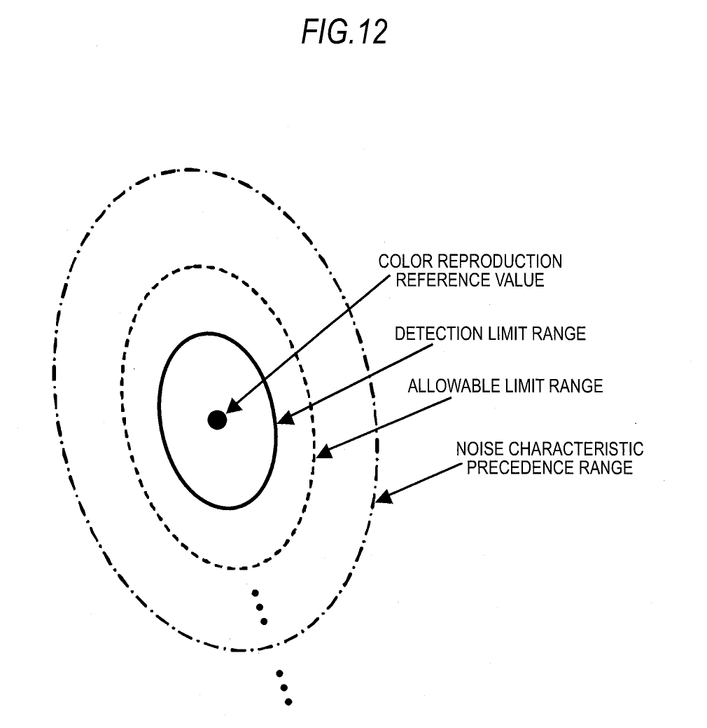

As shown in FIG. 12, for example, the range size can be set by applications with conditions that the detection limit range in which color discrepancy is not able to be detected (perceived) by a human eye is applied as the strictest determination range and the allowable limit range in which color discrepancy can be detected but is an allowable level is applied as the second strictest determination range. Accordingly, the range size of a color reproduction determination range can be dynamically set depending on the color reproduction reference value (target color reproduction) in a color space.

It is preferable that the range size and the color reproduction reference value of a color reproduction determination range be dynamically set at a rate not giving a visual sense of discomfort (for example, at a rate corresponding to periods of 0 to plural display frames) on the basis of a variation in ambient brightness or a variation in color ratio.

### 2-3. Color Signal Processing Unit

The description will be made again with reference to the system configuration shown in FIG. 1. As shown in FIG. 1, the color signal processing unit, that is, the color matrix unit 15, includes a color reproduction reference value generating unit 21, a color reproduction determination range generating unit 22, a determination unit 23, and a color reproduction correction value generating unit 24.

The color reproduction reference value generating unit 21, the color reproduction determination range generating unit 22, the determination unit 23, and the color reproduction correction value generating unit 24 may be embodied by hardware or the functions of these circuit units may be embodied by software using a microcomputer.

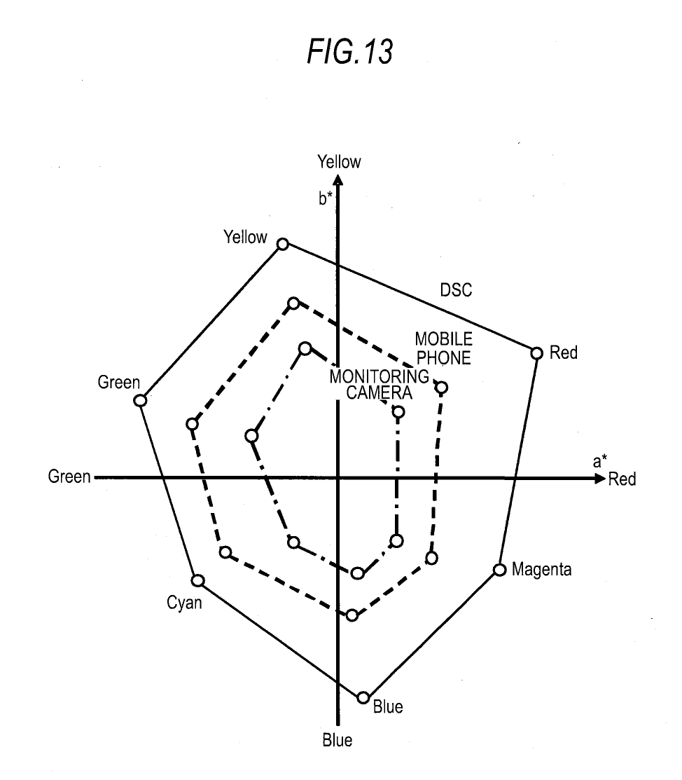

The color reproduction reference value generating unit 21 determines a color reproduction reference value by categories. Here, the term “categories” includes a digital still camera (DSC), a mobile phone camera, and a monitoring camera. For example, the color reproduction reference value for a DSC has a high degree of saturation and superior color reproducibility. On the contrary, the color reproduction reference value of a category not having priority in color reproduction such as a monitoring camera has a low degree of saturation. FIG. 13 shows an example of the color reproduction reference values set by categories.

The color reproduction determination range generating unit 22 generates a color reproduction determination range by arbitrarily or automatically selecting the picture-making idea (application), the imaging scene, and the category. Specifically, in the case of a picture-making idea (see FIG. 12) having priority in color reproduction, the color reproduction determination range is set to be small so as to apply the color reproduction correction value which becomes closest to the color reproduction reference value. On the contrary, in the case of a picture-making idea having priority in noise characteristics, the color reproduction determination is set to be large so as to reduce the color reproduction correction value.

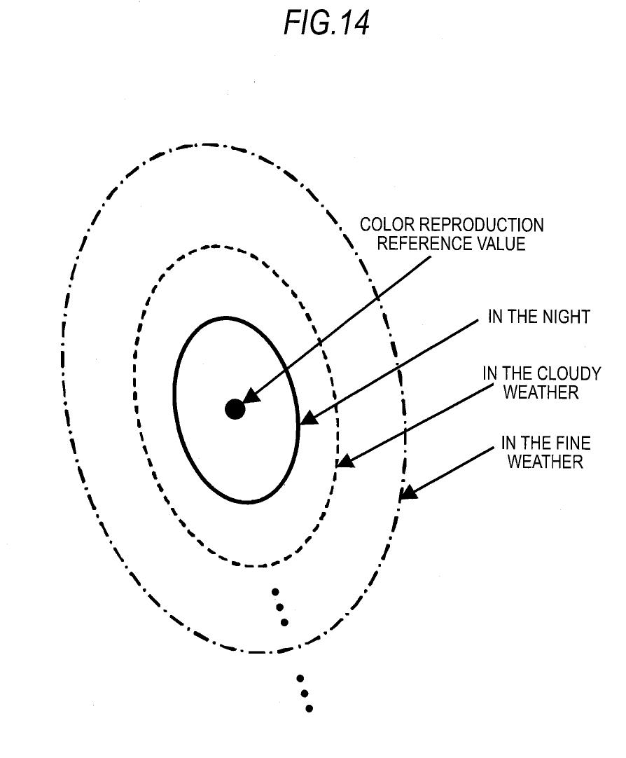

Examples of the imaging scene include an imaging scene in the fine weather, an imaging scene in the cloudy weather, an imaging scene in the sunset, and an imaging scene in the night. As shown in FIG. 14, for example, in the night, since it is difficult to perceive the variation in color, the color reproduction determination range is set to be small. On the contrary, in the clear weather, since it is easy to perceive a variation in color, the color reproduction determination range is set to be large.

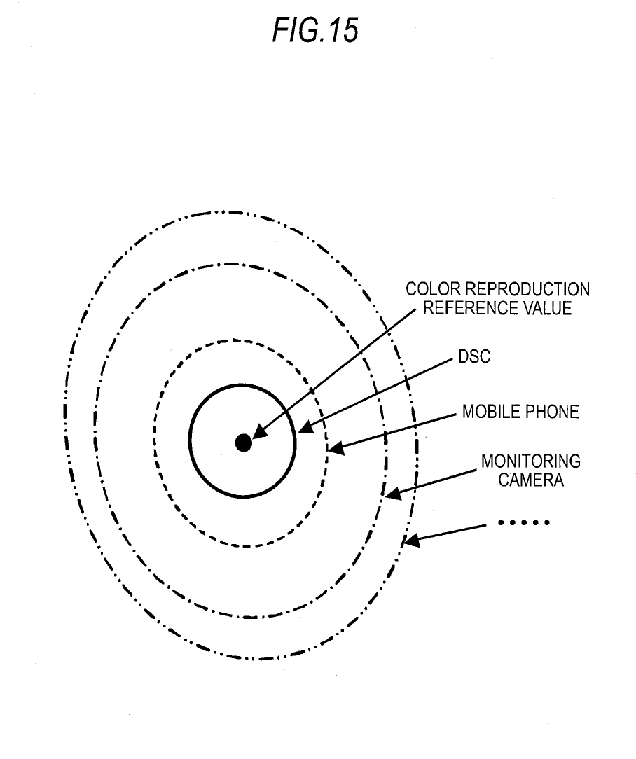

Examples of the category include a digital still camera (DSC), a mobile phone camera, and a monitoring camera. As shown in FIG. 15, in the case of a digital still camera, a camcorder, or the like, since color reproduction of a skin color of a person or the like has priority, the strictest (the smallest-size) determination range is set with a focus on the color reproduction. On the other hand, in the case of a monitoring camera such as a security camera, since the feeling of noise has priority rather than the color reproduction, the color correction is performed with a focus on the feeling of noise by sacrificing color reproducibility to lower the determination level (to broaden the range).

The determination unit 23 determines whether the color reproduction characteristics calculated from spectral sensitivity characteristics of the imaging device 12 belong to the color reproduction determination ranges generated by the color reproduction determination range generating unit 22. When the determination unit 23 determines that the color reproduction characteristics of the imaging device 12 belong to the color reproduction determination ranges, the above-mentioned process in the color matrix 15 is ended.

When the color reproduction characteristics of the imaging device 12 do not belong to the color reproduction determination ranges, the color reproduction correction value generating unit 24 receives the determination result of the determination unit 23, and repeatedly perform a process of applying the color reproduction correction value so as to cause the color reproduction characteristics to belong to the color reproduction determination ranges.

The color signal processing circuit according to the embodiment of the present disclosure, that is, the color matrix unit 15, is not limited to perform the correction processor a specific single color, but may simultaneously perform on plural colors.

### 2-4. Color Signal Processing Method

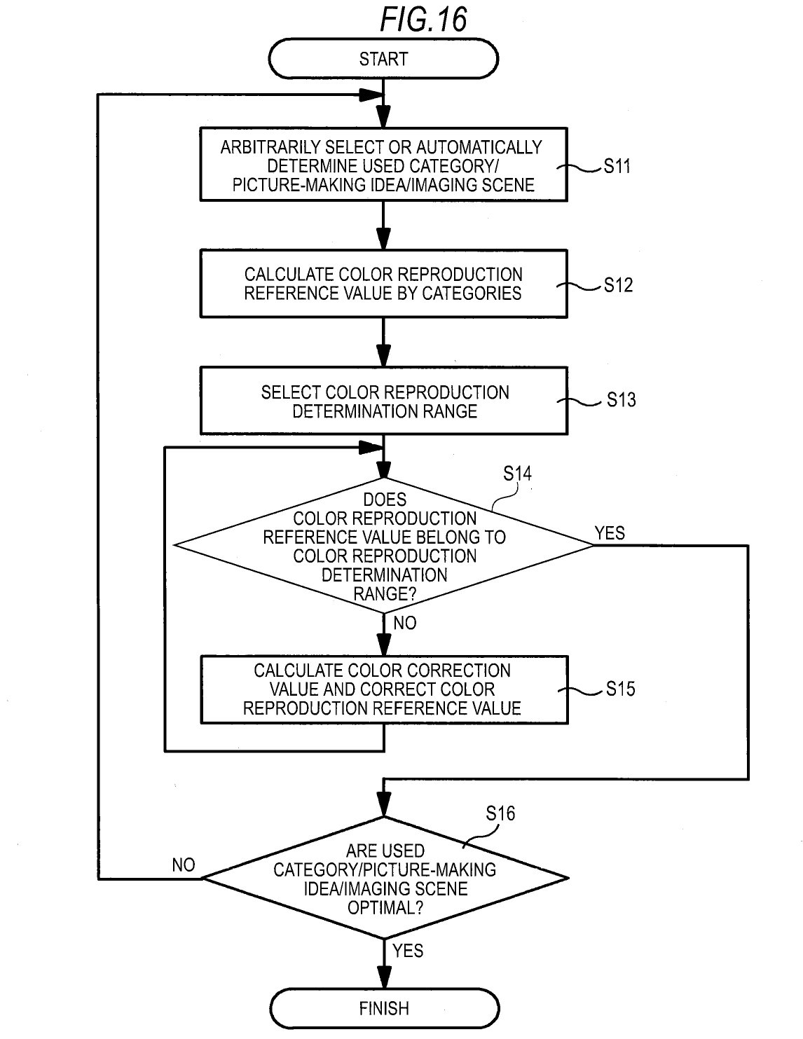

An example of a process flow of the color signal processing method according to the embodiment of the present disclosure will be described below with reference to the flowchart of FIG. 16.

First, the used category (such as a DSC, a mobile phone camera, and a monitoring camera), the picture-making idea (such as an idea having priority in color reproduction and an idea having priority in a feeling of noise), and an imaging scene (such as daytime and night) are arbitrarily or automatically determined (step S11). A known determination function mounted on the camera can be used for the automatic determination.

Color reproduction reference values are determined on the basis of the category, the picture-making idea, and the imaging scene determined in step S11 (step S12). Color reproduction determination ranges are determined on the basis of the category, the picture-making idea, and the imaging scene determined in step S11 and the color reproduction reference values determined in step S12 (step S13).

Then, it is determined whether the color reproduction characteristics calculated from the spectral sensitivity characteristics of the imaging device 12 belong to the color reproduction determination ranges determined in step S13 (step S14). When it is determined that the color reproduction characteristics do not belong to the color reproduction determination range, a correction process using the color correction values is performed to cause the color reproduction characteristics to belong to the color reproduction determination range (step S15) and then the above-mentioned series of processes are repeatedly performed from step S11 (step S15). The processes are repeatedly performed until it is determined in step S14 that the color reproduction characteristics belong to the color reproduction determination range.

When it is determined in step S14 that the color reproduction characteristics belong to the color reproduction determination range, it is normally determined whether the conditions such as the imaging scenes are optimal (step S16). When it is determined that the conditions are optimal, the process flow is ended. When it is determined that the conditions are not optimal, the above-mentioned series of processes are performed again from step S11. Accordingly, for example, when the camera suddenly moves from a bright place to a dark place, the process of determining the color reproduction reference values and the color reproduction determination ranges again or the like can be performed.

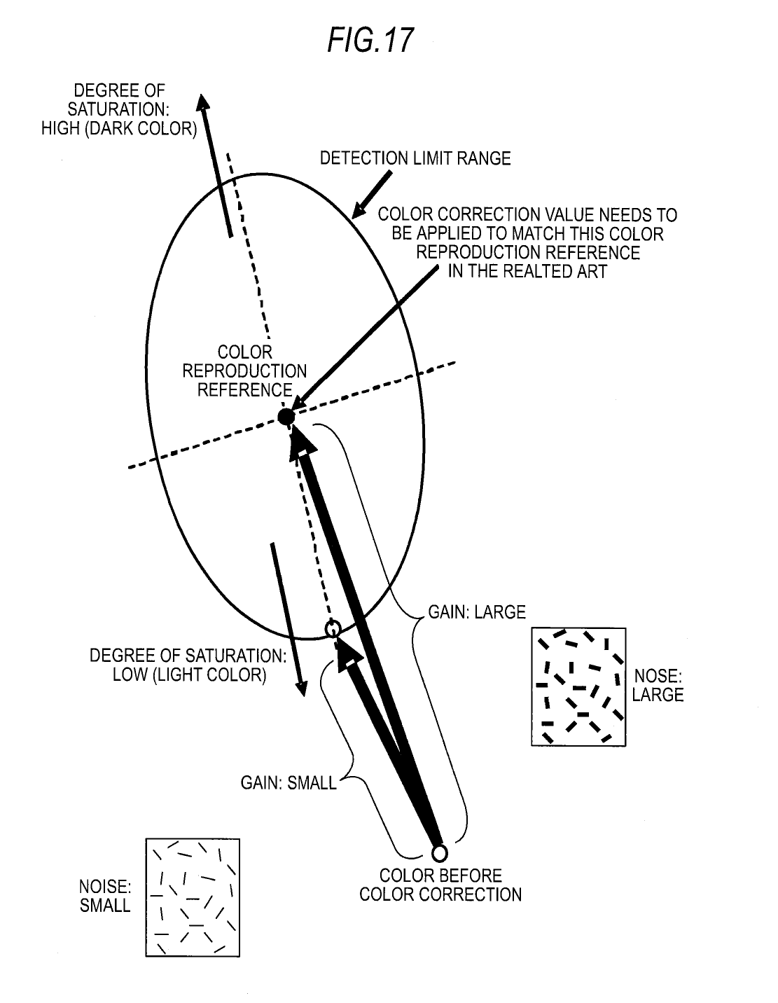

In the above-mentioned technique of the color signal processing circuit or the color signal processing method according to the embodiment of the present disclosure, it is possible to obtain the following operations and advantages. That is, as shown in FIG. 17, in the technique (for example, the technique described in JP-A-2005-159879) according to the related art not using the color reproduction determination range, since the color reproduction correction value should match the color reproduction reference value, an excessive color reproduction correction value may be applied (gain: large) and the degradation of an image may be caused (noise: large).

On the contrary, by setting the color reproduction determination ranges in the chromaticity diagram and performing a correction process to cause the color reproduction characteristics of the imaging device 12 to belong to the color reproduction determination ranges, it is possible to apply the optimal color reproduction correction value (gain: small) without damaging the color reproduction. Therefore, it is possible to realize the optimal imaging and picture-making operations (noise: small) without causing a degradation of an image.

By allowing the imaging apparatuses such as a DSC, a mobile phone camera, and a monitoring camera to use the technique of the color signal processing circuit or the color signal processing method according to the embodiment of the present disclosure, there is an advantage that when the color reproduction of an imaging device degrades due to the aging degradation, it is possible to automatically return the color reproduction to the state before the degradation.

By reducing a red-based color correction value to a level at which color reproducibility is not able to be perceived in the color reproduction determination range of red when capturing an image under a dark environment having illuminance lower than predetermined illuminance, it is possible to perform color correction to obtain the optimal feeling of noise depending on the level of color noise of pixels.

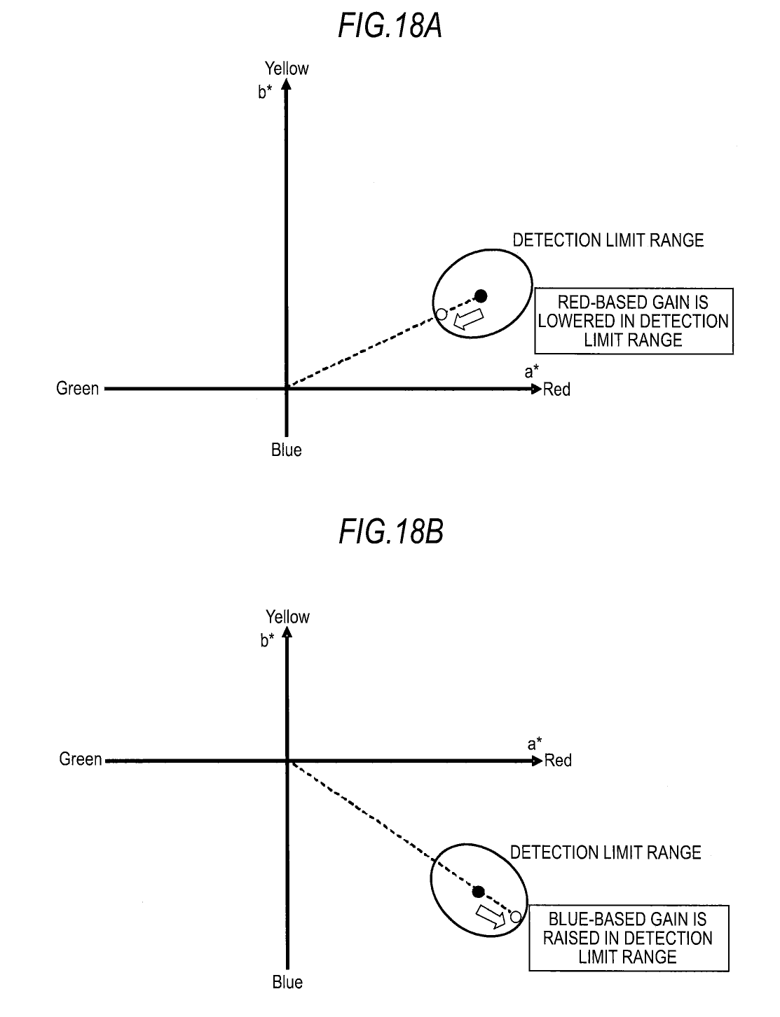

For example, red-based noise (σa*) is more conspicuous for a human eye rather than blue-based noise (σb*). When capturing an image under a dark environment with low illuminance or the like, it is assumed that there is an image with a sense of discomfort in which red-based noise is conspicuous. In this case, as shown in FIG. 18A, it is possible to obtain an image without a sense of discomfort by reducing a red-based color correction value to a level at which color reproducibility is not able to be perceived by a human eye in the color reproduction determination range of red. On the contrary, as shown in FIG. 18B, it is possible to obtain an image without a sense of discomfort by increasing a blue-based color correction value to a level at which color reproducibility is not able to be perceived by a human eye in the color reproduction determination range of blue.

### 3. Imaging Apparatus according to Second Embodiment

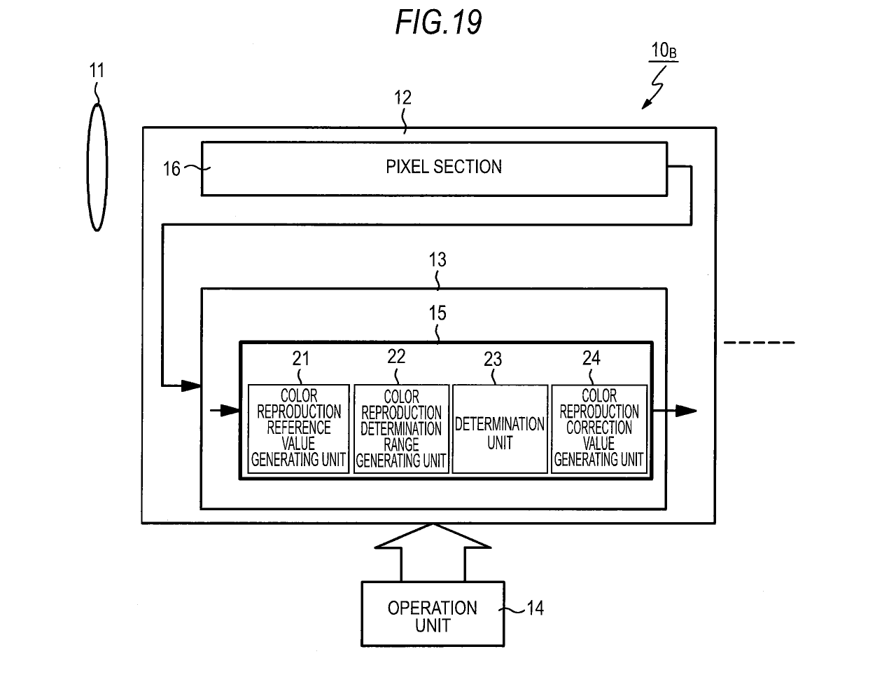

FIG. 19 is a system configuration diagram schematically illustrating the configuration of an imaging apparatus according to a second embodiment of the present disclosure. Similarly to the first embodiment, examples of the imaging apparatus include a digital still camera, a video camera, a mobile phone camera, and a monitoring camera.

As shown in FIG. 19, an imaging apparatus 10_{B} according to the second embodiment includes an optical system including a lens 11, an imaging device 12, and an operation unit 14. The imaging device 12 may be a charge transfer solid-state imaging device such as a CCD image sensor or an enhancement type solid-state imaging device such as a COMS image sensor.

The imaging apparatus 10_{B} according to the second embodiment has a configuration in which a DSP unit 13 as a signal processing unit is built in the chip of the imaging device 12. That is, the imaging device 12 of the imaging apparatus 10_{B} according to the second embodiment has a configuration in which a pixel section (imaging unit) 16 having sensor portions (pixels) two-dimensionally arranged and the DSP unit 13 are unified.

The unified structure may be a horizontal arrangement type in which the pixel section 16 and the DSP unit 13 are horizontally arranged in the same board or a vertical arrangement type in which the pixel section 16 and the DSP unit 13 are vertically arranged.

In this way, the technique of the signal processing circuit or the signal processing method according to the embodiment of the present disclosure can be applied to the imaging apparatus 10_{B} according to the second embodiment in which the pixel section 16 and the DSP unit 13 are unified. That is, the DSP unit 13 according to the first embodiment, that is, the DSP unit 13 including the color matrix unit (color signal processing unit) 15 to which the technique of the color signal processing circuit or the color signal processing method according to the embodiment of the present disclosure is applied can be used as the DSP unit 13.

In the first and second embodiments, an imaging apparatus detecting an incident light intensity distribution of visible rays and capturing an image is premised, but the embodiments are not limited to application to the imaging apparatus. The technique of the embodiment of the present disclosure can be applied to an imaging apparatus capturing an influx distribution of infrared rays, X-rays, or particles as an image.

The technique according to the embodiment of the present disclosure, that is, the technique of the color signal processing circuit or the color signal processing method according to the embodiment of the present disclosure, is not limited to application to imaging apparatuses such as a DSC, a mobile phone camera, and a monitoring camera, but can be applied to all electronic apparatuses that treat a color signal, such as a copier, a facsimile, and a color printer.

### 4. Application Example

The technique of the color signal processing circuit or the color signal processing method according to the embodiment of the present disclosure can be applied to a technique of evaluating color difference (color discrepancy) of color reproduction. The technique of color reproduction evaluation can be used for a testing device (so-called tester) that evaluates characteristics of a device such as oblique incidence characteristics of an imaging device.

For example, when evaluating oblique incidence characteristics of an imaging device, that is, characteristics to light obliquely incident on the sensor portions (pixels), a so-called shading phenomenon of light occurs due to the obliquely-incident light and an expected amount of light is not concentrated on the pixel section, thereby causing degradation in color reproducibility. In the related art, the degree of degradation in color reproducibility is sensitively evaluated.

On the contrary, in the technique of the color signal processing circuit or the color signal processing method according to the embodiment of the present disclosure, anyone can perform evaluation (sorting) easily, satisfactorily, and accurately, by evaluating color difference (color discrepancy) in color reproduction using a quantitative color reproduction determination range.

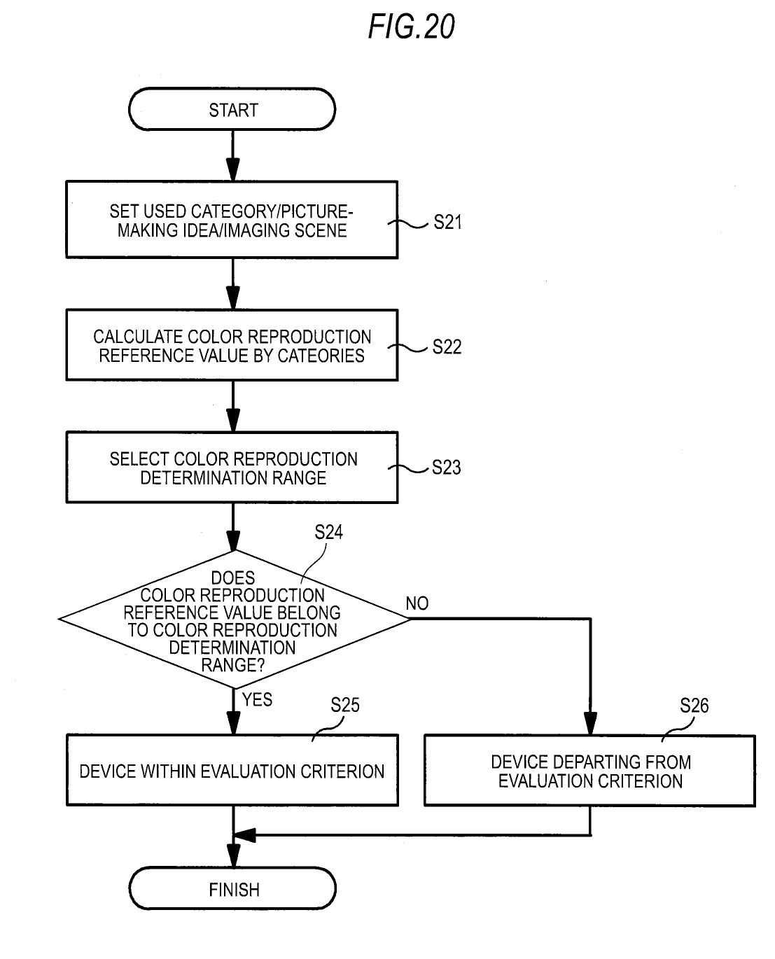

An example of a specific process flow of the color reproduction evaluating method according to the embodiment of the present disclosure will be described with reference to the flowchart shown in FIG. 20. Here, an example where a device to be evaluated is an imaging device will be described.

First, a used category (DSC/mobile phone camera/monitoring camera) and the like, a picture-making idea (having priority in color reproduction, having priority in the feeling of noise, and the like), and an imaging scene (in the daytime, in the night, and the like) are set (step S21), and a color reproduction reference value is determined as valuation criteria from the set category/picture-making idea/imaging scene (step S22). A color reproduction determination range is determined on the basis of the category/picture-making idea/imaging scene determined in step S21 and the color reproduction reference value determined in step S22 (step S23).

Then, it is determined whether color reproduction characteristics calculated from spectral sensitivity characteristics of the imaging device belong to the color reproduction determination range determined in step S23 (step S24). When it is determined that the color reproduction characteristics belong to the color reproduction determination range (Yes), the imaging device is determined to be a device (OK) within the evaluation criteria (step S25). When it is determined that the color reproduction characteristics do not belong to the color reproduction determination range, the imaging device is determined to be a device (NG) departing from the evaluation criteria (step S26). Devices are sorted in this manner.

### 5. Configuration of Present Disclosure

The present disclosure may employ the following configurations.

(1) A color signal processing circuit that performs a correction process on an input color signal so as to cause a color component to belong to a color reproduction determination range, which is set in a chromaticity diagram to define an allowable range of color discrepancy, using the color reproduction determination range.

(2) The color signal processing circuit according to (1), wherein the color reproduction determination range quantitatively represents an allowable range of color discrepancy in consideration of human visibility characteristics.

(3) The color signal processing circuit according to (1) or (2), wherein the color reproduction determination range includes an allowable limit range that defines an allowable limit of color discrepancy.

(4) The color signal processing circuit according to (3), wherein the color reproduction determination range includes a detection limit range that defines a limit in which color discrepancy can be detected by a human eye.

(5) The color signal processing circuit according to any one of (1) to (4), wherein the color reproduction determination range is applicable to all colors that can be expressed in at least color spaces of an L*a*b* chromaticity diagram space and an L*u*v* chromaticity diagram space.

(6) The color signal processing circuit according to any one of (1) to (5), wherein the color reproduction determination range is set for each basic color of three primary colors and complementary colors thereof.

(7) The color signal processing circuit according to any one of (1) to (6), wherein the color reproduction determination range includes a color reproduction determination range for a color other than the basic colors in addition to color reproduction determination ranges for the basic colors, and the color reproduction determination range of the color other than the basic colors is set through the use of an interpolation process based on the color reproduction determination ranges of the basic colors.

(8) The color signal processing circuit according to any one of (1) to (7), wherein a range size and a color reproduction reference value of the color reproduction determination range are set by applications of the color reproduction determination range.

(9) The color signal processing circuit according to any one of (1) to (7), wherein a range size of the color reproduction determination range is dynamically set on the basis of a color reproduction reference value in a color space.

(10) A color signal processing method including: setting a color reproduction determination range, which defines an allowable range of color discrepancy, in a chromaticity diagram; and performing a correction process on an input color signal so as to cause a color component to belong to the color reproduction determination range.

(11) A color reproduction evaluating method including: setting a color reproduction determination range, which defines an allowable range of color discrepancy, in a chromaticity diagram; and evaluating whether a color signal input from a device belong to the color reproduction determination range.

(12) The color reproduction evaluating method according to (11), wherein the device is an imaging device, and oblique incidence characteristics of the imaging device are evaluated.

(13) An imaging apparatus including: an imaging unit that captures a subject image; and a color signal processing circuit that performs a correction process on a captured image signal input from the imaging unit so as to cause a color component to belong to a color reproduction determination range, which is set in a chromaticity diagram to define an allowable range of color discrepancy, using the color reproduction determination range.

(14) The imaging apparatus according to (13), wherein a range size and a color reproduction reference value of the color reproduction determination range are set by imaging scenes.

(15) The imaging apparatus according to (13), wherein a range size and a color reproduction reference value of the color reproduction determination range are set by categories.

(16) The imaging apparatus according to (13), wherein a range size and a color reproduction reference value of the color reproduction determination range are dynamically set at a rate not giving a visual sense of discomfort on the basis of a variation in ambient brightness and a variation in color ratio.

(17) The imaging apparatus according to (13), wherein the color reproduction determination range is set for each basic color of three primary colors of light and complementary colors thereof, and the color signal processing circuit reduces a red-based color correction value to a level at which color reproducibility is not able to be perceived in the color reproduction determination range of red when capturing an image under an environment having illuminance lower than predetermined illuminance.

(18) The imaging apparatus according to (13), wherein the color reproduction determination range is set for each basic color of three primary colors of light and complementary colors thereof, and the color signal processing circuit reduces a blue-based color correction value to a level at which color reproducibility is not able to be perceived in the color reproduction determination range of blue when capturing an image under an environment having illuminance lower than predetermined illuminance.

(19) An electronic apparatus having a color signal processing circuit that performs a correction process on an input color signal so as to cause a color component to belong to a color reproduction determination range, which is set in a chromaticity diagram to define an allowable range of color discrepancy, using the color reproduction determination range.

(20) A testing device that sorts quality of a device by evaluating whether a color signal input from the device belongs to a color reproduction determination range, which is set in a chromaticity diagram to define an allowable range of color discrepancy, using the color reproduction determination range.

The present disclosure contains subject matter related to that disclosed in Japanese Priority Patent Application JP 2012-086263 filed in the Japan Patent Office on Apr. 5, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A color signal processing circuit that performs a correction process on an input color signal so as to cause a color component to belong to a color reproduction determination range, which is set in a chromaticity diagram to define an allowable range of color discrepancy, using the color reproduction determination range.

2. The color signal processing circuit according to claim 1, wherein the color reproduction determination range quantitatively represents an allowable range of color discrepancy in consideration of human visibility characteristics.

3. The color signal processing circuit according to claim 1, wherein the color reproduction determination range includes an allowable limit range that defines an allowable limit of color discrepancy.

4. The color signal processing circuit according to claim 3, wherein the color reproduction determination range includes a detection limit range that defines a limit in which color discrepancy can be detected by a human eye.

5. The color signal processing circuit according to claim 1, wherein the color reproduction determination range is applicable to all colors that can be expressed in at least color spaces of an L*a*b* chromaticity diagram space and an L*u*v* chromaticity diagram space.

6. The color signal processing circuit according to claim 1, wherein the color reproduction determination range is set for each basic color of three primary colors and complementary colors thereof.

7. The color signal processing circuit according to claim 1, wherein the color reproduction determination range includes a color reproduction determination range for a color other than the basic colors in addition to color reproduction determination ranges for the basic colors, and
wherein the color reproduction determination range of the color other than the basic colors is set through the use of an interpolation process based on the color reproduction determination ranges of the basic colors.

8. The color signal processing circuit according to claim 1, wherein a range size and a color reproduction reference value of the color reproduction determination range are set by applications of the color reproduction determination range.

9. The color signal processing circuit according to claim 1, wherein a range size of the color reproduction determination range is dynamically set on the basis of a color reproduction reference value in a color space.

10. A color signal processing method comprising:
setting a color reproduction determination range, which defines an allowable range of color discrepancy, in a chromaticity diagram; and
performing a correction process on an input color signal so as to cause a color component to belong to the color reproduction determination range.

11. A color reproduction evaluating method comprising:
setting a color reproduction determination range, which defines an allowable range of color discrepancy, in a chromaticity diagram; and
evaluating whether a color signal input from a device belong to the color reproduction determination range.

12. The color reproduction evaluating method according to claim 11, wherein the device is an imaging device, and
wherein oblique incidence characteristics of the imaging device are evaluated.

13. An imaging apparatus comprising:
an imaging unit that captures a subject image; and
a color signal processing circuit that performs a correction process on a captured image signal input from the imaging unit so as to cause a color component to belong to a color reproduction determination range, which is set in a chromaticity diagram to define an allowable range of color discrepancy, using the color reproduction determination range.

14. The imaging apparatus according to claim 13, wherein a range size and a color reproduction reference value of the color reproduction determination range are set by imaging scenes.

15. The imaging apparatus according to claim 13, wherein a range size and a color reproduction reference value of the color reproduction determination range are set by categories.

16. The imaging apparatus according to claim 13, wherein a range size and a color reproduction reference value of the color reproduction determination range are dynamically set at a rate not giving a visual sense of discomfort on the basis of a variation in ambient brightness and a variation in color ratio.

17. The imaging apparatus according to claim 13, wherein the color reproduction determination range is set for each basic color of three primary colors of light and complementary colors thereof, and
wherein the color signal processing circuit reduces a red-based color correction value to a level at which color reproducibility is not able to be perceived in the color reproduction determination range of red when capturing an image under an environment having illuminance lower than predetermined illuminance.

18. The imaging apparatus according to claim 13, wherein the color reproduction determination range is set for each basic color of three primary colors of light and complementary colors thereof, and
wherein the color signal processing circuit reduces a blue-based color correction value to a level at which color reproducibility is not able to be perceived in the color reproduction determination range of blue when capturing an image under an environment having illuminance lower than predetermined illuminance.

19. An electronic apparatus having a color signal processing circuit that performs a correction process on an input color signal so as to cause a color component to belong to a color reproduction determination range, which is set in a chromaticity diagram to define an allowable range of color discrepancy, using the color reproduction determination range.

20. A testing device that sorts quality of a device by evaluating whether a color signal input from the device belongs to a color reproduction determination range, which is set in a chromaticity diagram to define an allowable range of color discrepancy, using the color reproduction determination range.
